(19) United States
(12) Patent Application Publication
(10) Pub. No.: US 2004/0205704 A1
(43) Pub. Date: Oct. 14, 2004

(54) Transparent monitoring system and method for examining an executing program in real time

(76) Inventors: Donald W. Miller JR., Fairview, TX (US); Alfred J. Blanchard, Plano, TX (US); Kurt A. McIntyre, Plano, TX (US); Michael E. Hellemn, Plano, TX (US)

Correspondence Address: ALCATEL USA, INTELLECTUAL PROPERTY DEPARTMENT, 3400 W. PLANO PARKWAY, MS LEGL2, PLANO, TX, 75075, US

(21) Appl. No.: 10/385,545

(22) Filed: Mar. 11, 2003

Related U.S. Application Data
(63) Continuation of application No. 09/528,521, filed on Mar. 20, 2000, now abandoned.
(60) Provisional application No. 60/173,179, filed on Dec. 27, 1999.

(51) Int. Cl. G06F 9/00

(52) U.S. Cl. 717/109; 719/328

(57) ABSTRACT

A system (10) for examining an executing program in real time includes a program analyzer (12) that allows a user access to an executing program (14) through a user interface (16). The program analyzer (12) provides for the viewing of the executing program (14) during its operation and allows the user to change data in an associated memory (16) and perform patches to the code of the executing program (14) to correct errors that have been recognized during operation.

### BACKGROUND OF THE INVENTION

During execution of a computer program, errors may occur in the program. These errors must be addressed or otherwise the program may not operate as intended. Typically, a customer having problems with the operation of the program call in computer support personnel to fix the problem. The computer support personnel will, in most cases, not have access to the source code of the program because program developers do not distribute the source code in order to protect their investment. Moreover, it is difficult to compile a source code from the program because there is no effective method to map source routines to a specific fixed location in the program in order to figure out what the program was doing when an error occurred. The operating system for the program assigns addresses and values to program components that can change each time the program executes. If there is a capability to attach a source level debugger to the program, such as in testing during program development, the program would have to be halted in order to perform error analysis. Halting a program to analyze errors is not effective in the field of telecommunications as it may be detrimental to communications in a network to have a switch stop its call processing capability just to debug some minor errors. Moreover, a source level debugger may not be able to recreate the error due to the halting of the program. Timing variables and initializations may make it impossible to recreate the error using a source level debugger. Therefore, it is desirable to effectively analyze a program without access to its source code and without halting it for debugging purposes.

### SUMMARY OF THE INVENTION

From the foregoing, it may be appreciated by those skilled in the art that a need has arisen for a capability to debug a program while it is being executed. In accordance with the present invention, a transparent monitoring system and method for examining an executing program in real time are provided that substantially eliminate or reduce disadvantages and problems associated with conventional source level debugging techniques.

According to an embodiment of the present invention, there is provided a transparent monitoring system for examining an executing program in real time that includes the executing program with a program code and a program variable. A user interface may request data on the program code and the program variable during operation of the executing program. A program analyzer, in communication with the user interface and the executing program, determines a format and a character of the program code and the program variable. The program analyzer is the transport of information between the executing program and the user interface.

The present invention provides various technical advantages over conventional source level debugging techniques. For example, one technical advantage is to provide a capability to analyze a program during its execution. Another technical advantage is the ability to modify program content. Yet another technical advantage is to provide real time debugging on an executing program in an open system. Other technical advantages may be readily apparent to those skilled in the art from the following figures, description, and claims.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 illustrates a block diagram of a system for analyzing an executing program;

FIGS. 2A-K illustrate displays generated by a program analyzer in the system.

### DETAILED DESCRIPTION OF THE INVENTION

FIG. 1 is a block diagram of a system 10 for analyzing an executing program. System 10 includes a program analyzer 12 that interfaces with an executing program 14 and memory 16. Analysis of executing program 14 may be performed by a user through a user interface 18 in conjunction with program analyzer 12. Program analyzer 12 operates to analyze executing program 14 with information retrieved from operating system header files 20, program header files 22, global variable files 24, and local variable files 26. Access to all symbols of executing program 14 is available through a services element 30. Program analyzer 12 has access to executing program 14 through a background interface 32.

Program analyzer 12 provides an unobtrusive examination of executing program 14 without debugging information. Debugging information need not be compiled into executing program 14. Since debugging information affects the size and function of executing program 14, program analyzer 12 allows for developers to avoid the undesirable task of including debugging information in programs shipped to a field environment. The unobtrusive nature of program analyzer 12, especially in the telecommunications industry, provides a method to analyze real time telephony applications in the field without interrupting program execution. This method avoids the pause and step technique used by source level debuggers. Program analyzer 12 provides an ability to have an extended analysis of program image as well as large scale data abstraction over memory segments of executing program 14.

Executing program 14 is preferably in an executable and linkable format (ELF). Program analyzer 12 derives the format of executing program 14 directly from operating system header files 20. In this format, the image of executing program 14 can be displayed and analyzed. With access to program header files 22, program analyzer can display the data structure of executing program 14. User interface 18 allows a user to peruse and search program code and data space of executing program 14. System 10 may operate in all operating systems where service element 30 has been ported and is supported on such platforms as Sun Solaris OS 2.4/2.5.1, LynxOS 2.5, Linux 2.1.26, as well as other Unix platforms.

Services element 30 provides access to all symbols, both global and local, of executing program 14 to program analyzer 12 through global variable file 24 and local variable file 26. Services element 30 includes a runtime variable symbol table that is created when executing program 14 registers its symbols upon initialization. Executing program 14 provides a variable name, offset, and type for each of its symbols. Program analyzer 12 can then monitor and change any symbol registered for executing program 14. User interface 18 may also allow a user to monitor and change symbols of executing program 14 to correct identified errors.

Service element 30 provides a runtime debug and trace level control of executing program 14. A real-time interface for monitoring executing program 14 is provided without drastically affecting the actual runtime performance of executing program 14. Services element 30 allows for instrumentation and retrieval of program data for the dynamic control of the amount and severity of the traces produced by executing program 14. Service element 30 provides access to known symbol table information that is generated by executing program 14 at runtime upon registration. As part of the registration process, a daemon thread is established in executing program 14 that manages the symbol table information as well as many other control functions including program analyzer 12 for debug and trace tool requests.

Program analyzer 12 also registers with service element 30. In doing so, program analyzer 12 has access to task control block information of executing program 14 maintained in services element 30. Program analyzer 12 uses this information to determine what programs are available for debug or trace control. Access to the address space of executing program 14 is provided through a control message facility of services element 30. Program analyzer 12 formulates requests for various operations on executing program 14. Requests are sent to executing program 14 through a control message from service element 30. The control message is processed by the daemon thread in executing program 14. Information is returned by executing program 14 to program analyzer 12. Though shown separately, the functions of program analyzer 12 and service element 30 may be combined into a single unit.

The symbol table information of which service element 30 provides access includes a trace log matrix table and a runtime variable symbol table. The task control block information of executing program 14 includes an integer pointer reference to a process internal table. The value of the integer pointer reference is a process local address of a table that holds feature table offsets. One of the feature table offsets is the trace log matrix table and another of the feature table offsets is the runtime variable symbol table. Other additional features may include a compile time symbol table and a dump facility. These features may create a specific impact on the operation of executing program 14 and may require that executing program 14 provide base classes that can serialize themselves.

The trace log matrix table includes several entries for a trace matrix structure. The purpose of the trace matrix structure is to control output of trace log messages of executing program 14. The trace matrix structure includes several fields associated with one of several domain entries. Domain entries include message, fault management, configuration, initialization, database, and performance monitor. The fields of the trace matrix structure include a level field, a threshold field, and a count field. The level field defines a level of severity that is associated with the corresponding domain entry. The level field identifies a minimum level of a trace allowed for the domain entry. Any trace of lower severity is ignored and discarded. The threshold field identifies a minimum number of trace messages that are to be issued according to the level field prior to an actual trace message being issued. The threshold field acts as an automatic throttle for excessive trace output of a given severity. The count field is the current trace message issue counter for the defined level of severity. Once the threshold has been reached, the count field is reset.

The trace matrix structure is built at runtime with a default output level for each domain. The default output level per domain is defined to a trace subsystem of service element 30 at compile time. During program malfunction or as a part of fault isolation, the default output level may need to be modified to accommodate extended debugging. Program analyzer 12 has a capability to modify the default output level for each domain. To perform such modification, program analyzer 12 registers with service element 30 and reads and parses through the task control block information of executing program 14. Program analyzer 12 then reads and parses through the trace matrix structure and modifies levels for domains as desired.

Runtime variable symbol table includes tags that executing program 14 defines at runtime. These tags are added dynamically as entries to the table as executing program 14 initializes itself. Once populated, the entries in the runtime variable symbol table may be displayed by program analyzer 12. The tags are a list of application specific data offsets. These offsets include application specific data associated with executing program 14 that can be examined through program analyzer 12. Program analyzer 12 provides the capability to correctly interpret the application specific data. The process of defining these tags is known as instrumentation of the application. The format and content of the data component of the tags is not required by the daemon thread.

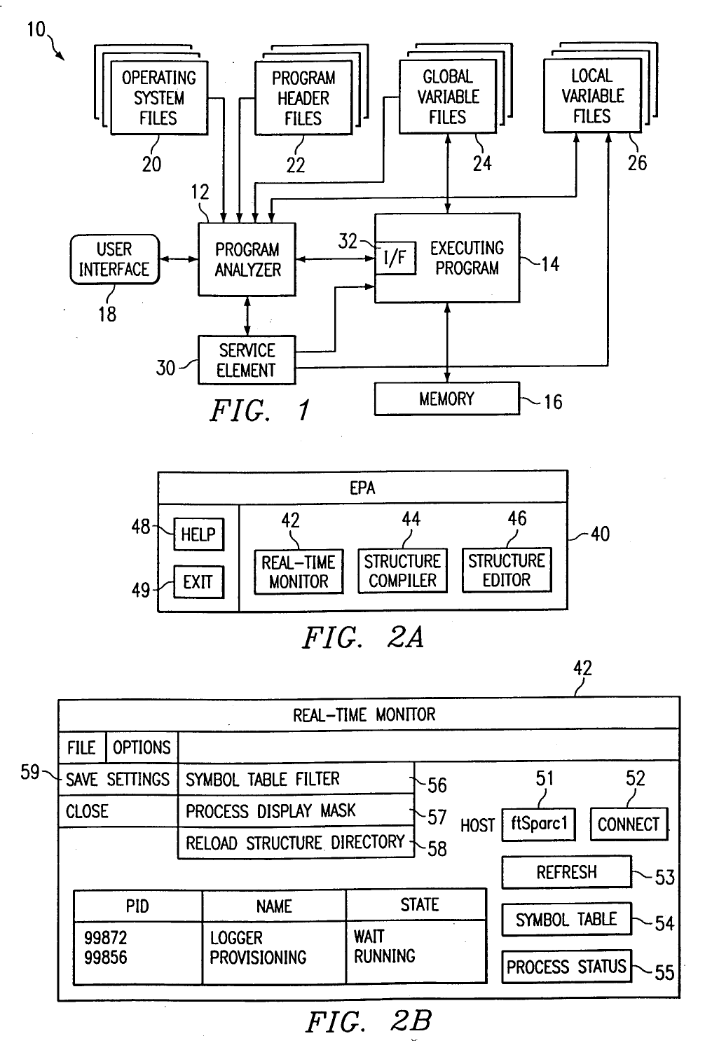

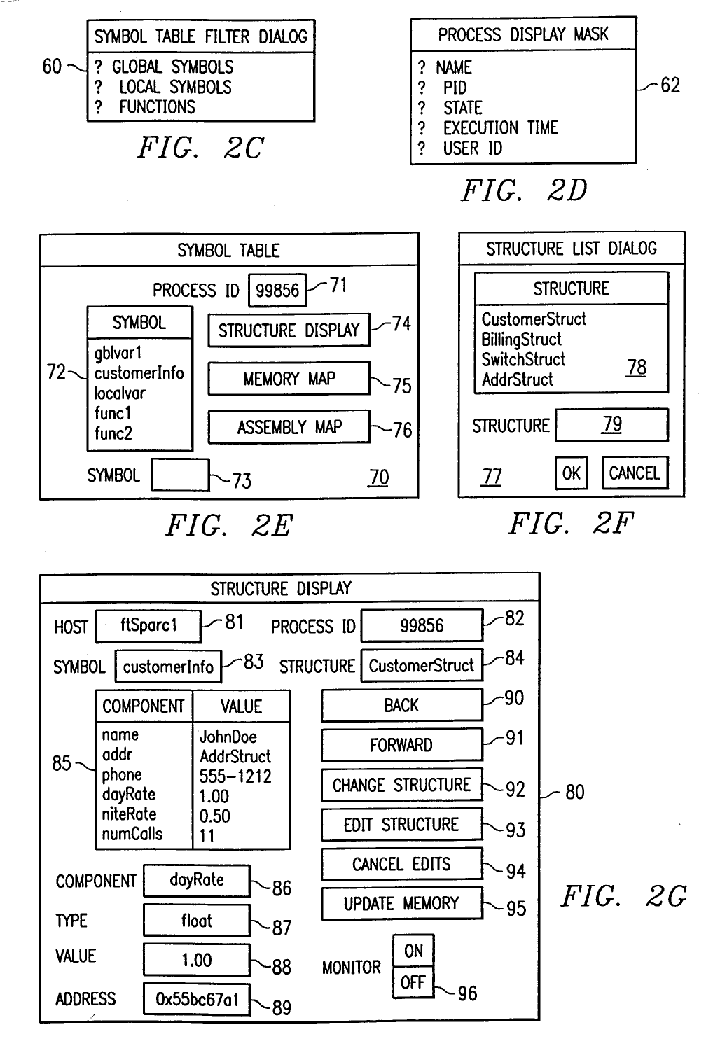

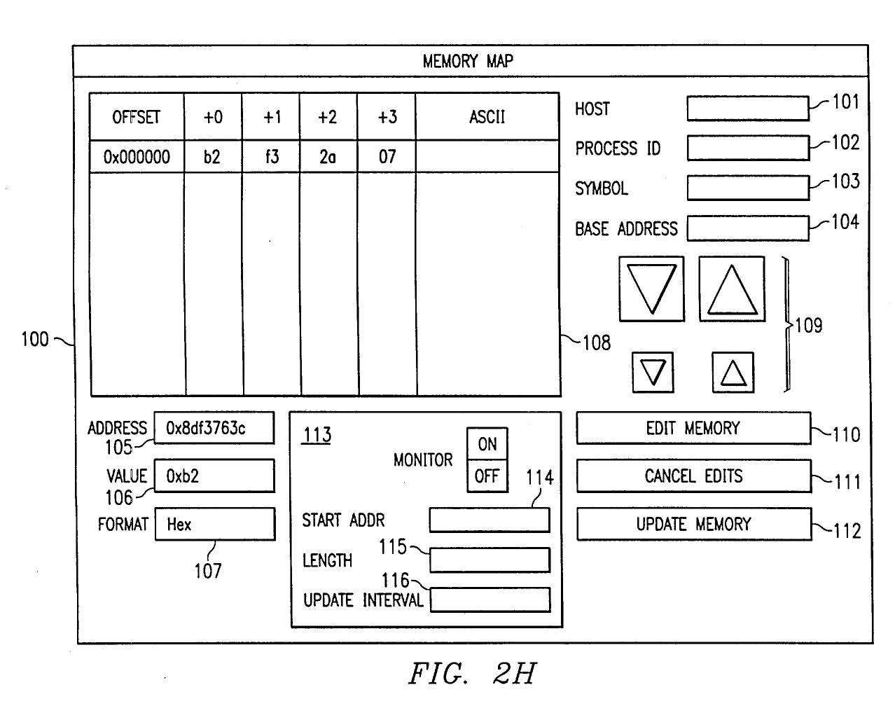

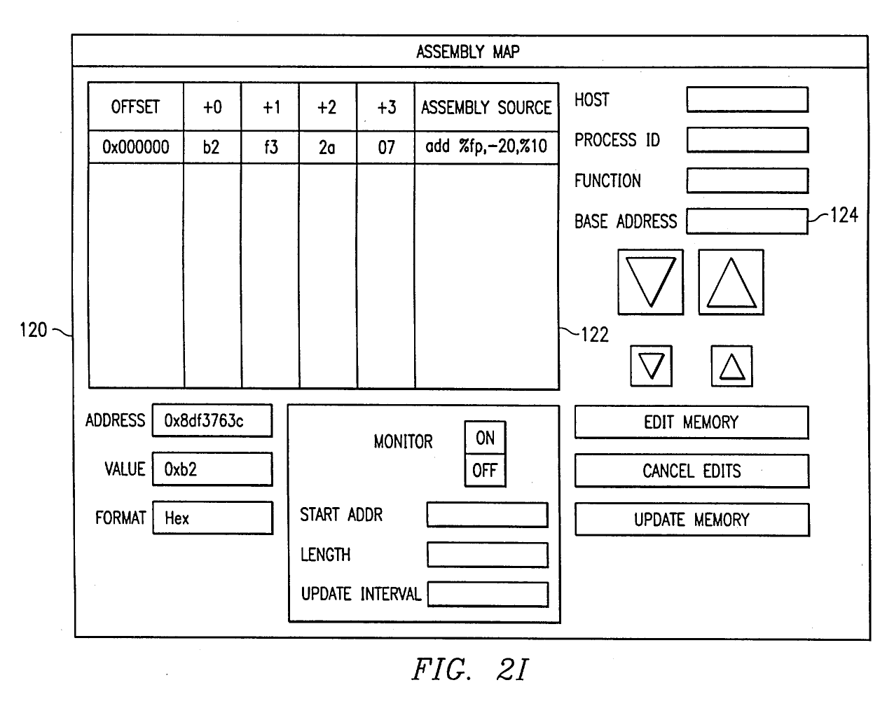

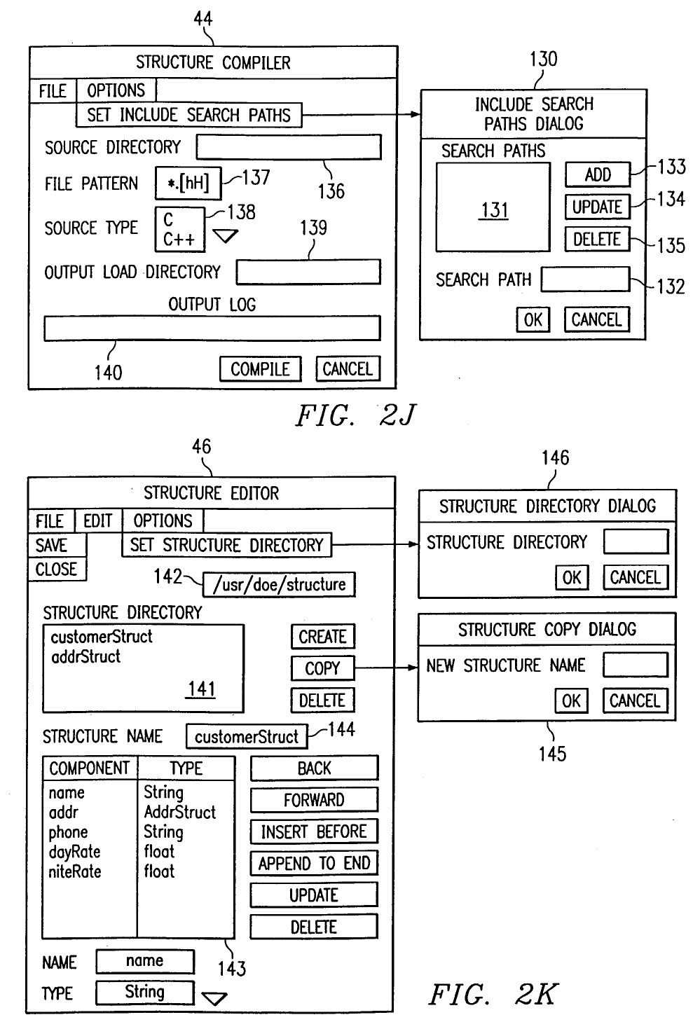

FIGS. 2A-K show the screen displays generated by program analyzer 12 for display on user interface 18. FIG. 2A is the launcher display 40 for program analyzer 12. Launcher display 40 provides access to a real-time monitor 42, a structure compiler 44, and a structure editor 46. A help element 48 provides assistance with program analyzer 12 to a user through user interface 18. An exit key 49 allows a user to terminate operation of program analyzer 12.

FIG. 2B shows the screen display for real-time monitor 42. Real-time monitor 42 displays a process list 50 of processes and their operating status that may be monitored. A user enters a name of a host machine in a host input field 51 and selects a connect option 52. A refresh option 53 allows the user to update the display of real-time monitor 42 with the most current process information. A symbol table option 54 begins a symbol table display for a process selected from process list 50. A process status option 55 starts a structure display that provides access to accounting and statistics information for the selected process.

Various additional options may be selected in real-time monitor 42. A symbol table filter option 56 provides for the selection of the type of symbols displayed on the symbol table display initiated by symbol table option 54. A processor display mask option 57 provides for the selection of information shown in processor list 50. A reload structure directory option 58 allows for the reload of structure information that provides representations of programming language structure and types. This information is used to present memory sections in a meaningful manner. A save settings option 59 in the file menu allows the symbol table filter and the process list to be saved for the next user session. Real-time monitor 42 may be closed from the file menu.

FIG. 2C shows a symbol table filter 60. Symbol table filter 60 allows the user to select the types of symbols, whether global or local, that are shown on the symbol table display provided by symbol table option 54. Symbol table filter 60 is accessed by symbol table filter option 56. FIG. 2D shows a process display mask dialog 62. Process display mask dialog 62 allows the user to select the type of process information shown in process list 50 such as process name, identification, state, execution time, and user identification. Process display mask dialog 62 is accessed by process display mask option 58.

FIG. 2E shows a symbol table display 70. Symbol table display 70 is accessed through symbol table option 54. Symbol table display 70 lists global program variables, local program variables, and all functions within executing program 14. Symbol table display 70 includes a process identification field 71, a symbol field 72, a symbol select field 73, a structure display option 74, a memory map option 75, and an assembly map option 76. Processor identification field 71 identifies the process (executing program 14) containing the symbols. Symbol field 72 displays the currently selected symbol. Symbol select field 73 allows for the selection of a symbol. Structure display option 74 allows the user to display a global or local variable formatted in the same way it was defined in a high level programming language. Selecting structure display option 74 starts a structure list dialog to provide user selection of which structure the variable should be mapped against. Memory map option 75 allows the user to view raw memory for any type of symbol. Assembly map option 76 provides for the disassembly of machine code for a function into assembly source instructions.

FIG. 2F shows a structure list dialog 77. Structure list dialog 77 is displayed when a symbol is selected from symbol field 72 or symbol select field 73 and when structure display option 74 is selected. Structure list dialog 77 displays all structures that have been compiled by a structure compiler and loaded by program analyzer 12. Structure list dialog 77 includes a structure list field 78 and a structure select field 79. The user may select a structure from structure list field 78 or structure select field 79. A structure display begins upon selecting and entering a structure. Canceling structure list dialog 77 returns the display to symbol table display 70.

FIG. 2G shows the structure display 80. Structure display 80 may be accessed through symbol table option 54, symbol table display 70, and structure list dialog 77. Structure display 80 may also be accessed through process status option 55. Structure display 80 presents a variable in a format consistent with how its structure was defined in a high level programming language. Structure display 80 includes a host field 81, a process identification field 82, a symbol field 83, a structure field 84, a component list 85, a component field 86, a type field 87, a value field 88, and an address field 89. Host field 81 displays a name of a machine for which processes are being analyzed. Process identification field 82 identifies the particular process (executing program 14) being analyzed. Symbol field 83 displays a name of a variable being examined. Structure field 84 displays which structure is being mapped on the memory for the variable identified in symbol field 83. Component list 85 is a scrollable region showing components within the selected structure and their values. Components within a structure may also be structures. Component list 85 provides for navigation through the selected structure and any nested structures therein.

Structure display 80 also provides various options, including a back option 90, a forward option 91, a change structure option 92, an edit structure option 93, a cancel edits option 94, an update memory option 95, and a monitor option 96. Back option 90 allows for navigation back one level of structure definition in an outward direction. Forward option 91 allows for navigation forward one level of structure definition in an inward direction. Change structure option 92 allows for mapping of a different structure onto variable memory. Edit structure option 93 allows for editing of component values in component list 85. Cancel edits option 94 allows for the cancellation of any edits made to the selected structure. Update memory option 95 allows any edits to be committed to memory 16. Monitor option 96 allows for the display of memory updates as they occur in executing program 14.

FIG. 2H shows a memory map 100. Memory map 100 is accessed through memory map option 75 of symbol table display 70. Memory map 100 displays raw memory for any symbol selected in symbol table display 70. Memory map 100 includes a host field 101, a process identification field 102, a symbol field 103, a base address field 104, an address field 105, a value field 106, a format field 107, and a memory list 108. Host field 101 shows a name of a machine for which executing program 14 is being analyzed. Process identification field 102 identifies the particular process (executing program 14) being analyzed. Symbol field 103 displays a name of a variable being examined. Base address field 104 contains a starting address for the variable being examined. Address field 105 shows an address for a selected word of memory. Value field 106 shows a value for the address shown in address field 105. Format field 107 shows a format for the value shown in value field 106.

Memory list 108 displays memory in octal, hexadecimal, or decimal formats. Memory list 108 includes an ASCII column to allow deciphering of string values. Arrows 109 may be used to scroll within memory list 108. Memory map 100 includes options that affect the memory displayed in memory list 108, such as an edit memory option 110, a cancel edits option 111, and an update memory option 112. Edit memory option 110 allows edits to be made to memory 16. Cancel edits option 111 cancels any edits made. Update memory option 112 commits the edits to memory while executing program 14 is running. A monitor box 113 allows the user to see updates to memory 16 as they occur. A selected portion of memory may be viewed using a starting address field 114 and a length field 115. The frequency of memory updates may be selected in an update memory field 116.

FIG. 21 shows an assembly map 120. Assembly map 120 is accessed through assembly map option 76 of symbol table display 70. Assembly map 120 has a similar appearance with similar fields and options as memory map 100. Assembly map 120 allows the user to view raw memory for any function selected in symbol table display 70. Memory that represents machine instructions may be edited and committed to executing program 14 during operation. Assembly map 120 includes an assembly list 122 in contrast to memory list 108 of memory map 100. Assembly list 122 includes an assembly source column that displays assembly code for a memory address in an offset column. In contrast to memory map 100, a base address field 124 shows a starting address for the function being examined.

FIG. 2J shows a structure compiler 44. Structure compiler 44 is accessed through launch display 40. Structure compiler 44 provides parsing of high level language files for structure definitions and to generate an internal representation for program analyzer 12. Structure compiler 44 allows the user to set the include search paths through an include search path dialog 130 needed to resolve all structure definitions. Search paths are shown in a search path list 131 and can be selected in a search path field 132. Search path options include add a search path 133, update a search path 134, and delete a search path 135. Changes to search paths may be entered or canceled as desired. A directory containing source code to be compiled is entered in a source directory field 136, a file pattern field 137, and a source type field 138. An output load directory field 139 determines where the structure representations used by program analyzer 12 are stored. An output log 140 may display the structure representations upon a request to compile.

FIG. 2K shows a structure editor 46. Structure editor 46 is accessed through launch display 40. Structure editor 46 is used to manually create structure definitions for program analyzer 12. Manual creation may be performed if executing program 14 was written in a high level language not supported by structure compiler 44. Structure editor 46 includes a structure list 141 that displays the structures for the structure directory identified in a structure directory field 142. A component list 143 shows the components and their types for a structure shown in structure list 141 as identified in a structure name field 144. A user may navigate, edit, and update components in component list 143 through options such as back, forward, insert before, append to end, update, and delete. Structures may be created or deleted. A copy dialog 145 allows for the copying of structures. A structure directory dialog 146 provides for the setting of a structure directory. Once a structure has been saved, it can be directly loaded by program analyzer 12.

In real-time applications, such as telephony, it is undesirable to shut down an executing application. It is advantageous, if possible, to make minor changes to the application while it is running. These minor changes, known as patches, can range from changing a simple value to modifying sections of code. Patches are desirable in that the changes are isolated to the modified code, as opposed to a new software build where code anywhere in the application may have changed. As shown above, program analyzer 12 allows a user to patch executing program 14 while it is running. The ability provided to display program code and data in readable formats facilitates the development of patches. Complex structures can be displayed and changed in their structure format. Code can be displayed in a disassembled form, allowing users to see code instructions rather than a dump of hexadecimal numbers. Program analyzer 12 greatly simplifies the process of analyzing problems in executing program 14 and creating patches thereto.

Thus, it is apparent that there has been provided, in accordance with the present invention, a transparent monitoring system and method for examining an executing program in real time that satisfies the advantages set forth above. Although the present invention has been described in detail, it should be understood that various changes, substitutions, and alterations may be readily ascertainable by those skilled in the art and may be made herein without departing from the spirit and scope of the present invention as defined by the following claims.

What is claimed is:

1. A transparent monitoring system for examining an executing program in real time, comprising:
a program code and a program variable defined in the executing program;
a user interface operable to request data on the program code and the program variable during operation of the executing program;
a program analyzer in communication with the user interface and the executing program, the program analyzer operable to determine a format and a character of the program code and the program variable, wherein the program analyzer communicates with the executing program to obtain the requested data on the program code and the program variable, the program analyzer communicating the requested data to the user interface during execution of the executing program, the user interface operable to monitor and modify the executing program during its execution.

2. The transparent monitoring system of claim 1, further comprising:
an operating system header file containing format and character information, the program analyzer operable to display an image of the executing program in response to the format and character information of the operating system header file.

3. The transparent monitoring system of claim 1, further comprising:
a global variable header file in communication with the executing program and the program analyzer, the global variable header file containing global variable information, the program analyzer operable to provide user access to the global variable file through the user interface.

4. The transparent monitoring system of claim 3, wherein the program variable is a global variable.

5. The monitoring system of claim 1, wherein the program variable is a local variable.

6. The transparent monitoring system of claim 1, wherein the user interface is a graphical user interface.

7. The transparent monitoring system of claim 1, further comprising:
a background interface operable to allow the program analyzer and the executing program to communicate.

8. The transparent monitoring system of claim 1, further comprising:
a service element in communication with the executing program, the service element providing access for the program analyzer to all variables of the executing program, the service element defining a global and a local variable header file of the executing program for use by the program analyzer.

9. The transparent monitoring system of claim 1, wherein the transparent monitoring system operates in a UNIX system environment.

10. The transparent monitoring system of claim 1, further comprising:
a memory coupled to the executing program, the program analyzer operable to display contents of the memory to the user interface during operation of the executing program.

11. A method of viewing in real time a program code and data variables of an executing program, comprising:
registering the variables of the executing program;
determining a format and a character of the program code and the data variables;
providing access to the program code and program variables during execution of the executing program.

12. The method of claim 11, further comprising:
modifying the program code during execution of the executing program.

13. The method of claim 11, further comprising:
modifying the variables during execution of the executing program.

14. The method of claim 11, further comprising:
modifying memory contents during execution of the executing program.

15. The method of claim 11, further comprising:
selecting one or more program variables for modification.

16. The method of claim 11, further comprising:
identifying an execution error in the executing program.

17. The method of claim 16, further comprising:
developing a code patch to correct the identified execution error.

18. The method of claim 17, further comprising:
modifying the program code with the code patch.

19. The method of claim 18, further comprising:
instantaneously viewing execution of the executing program upon modification of the program code.

20. The method of claim 19, wherein the executing program does not include debugging information.
